(19) United States
(12) Patent Application Publication
(10) Pub. No.: US 2006/0125928 A1
(43) Pub. Date: Jun. 15, 2006

(54) Scene and user image capture device and method

(75) Inventors: Dana W. Wolcott, Honeoye Falls, NY (US); Elena A. Fedorovskaya, Pittsford, NY (US); John C. Neel, Pittsford, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/009,806

(22) Filed: Dec. 10, 2004

(51) Int. Cl. G03B 17/48; H04N 5/222; H04N 5/232; G03B 19/00

(52) U.S. Cl. 348/211.2; 348/333.02

(57) ABSTRACT

An image capture device and methods are provided. The image capture device has a scene image capture system adapted to capture an image of a scene and a user image capture system adapted to capture an image of a user of the image capture device. A trigger system adapted to generate a capture signal and a controller is adapted to receive the capture signal and to cause an image to be captured by the user image capture system and the scene image capture system at substantially the same time. The controller is further adapted to associate the image of the user with the image of the scene.

### CROSS REFERENCE TO RELATED APPLICATIONS

Reference is made to commonly assigned, co-pending patent application U.S. Ser. No. 10/304,127, entitled IMAGING METHOD AND SYSTEM filed Nov. 25, 2002 in the names of Fedorovskaya et al.; U.S. Ser. No. 10/304,037, entitled IMAGING METHOD AND SYSTEM FOR HEALTH MONITORING AND PERSONAL SECURITY filed Nov. 25, 2002 in the names of Fedorovskaya et al.; U.S. Ser. No. 10/303,978, entitled CAMERA SYSTEM WITH EYE MONITORING filed Nov. 25, 2002 in the names of Miller et al.; U.S. Ser. No. 10/303,520, entitled METHOD AND COMPUTER PROGRAM PRODUCT FOR DETERMINING AN AREA OF IMPORTANCE IN AN IMAGE USING EYE MONITORING INFORMATION filed Nov. 25, 2002 in the names of Miller et al.; U.S. Ser. No. 10/846,310, entitled METHOD, APPARATUS AND COMPUTER PROGRAM PRODUCT FOR DETERMINING IMAGE QUALITY filed May 14, 2004 in the name of Fedorovskaya; and U.S. Ser. No. 10/931,658, entitled CONTROL SYSTEM FOR AN IMAGE CAPTURE DEVICE filed Sep. 1, 2004 in the names of Fredlund et al.

### FIELD OF THE INVENTION

The invention relates to an image capture device.

### BACKGROUND OF THE INVENTION

In a digital camera a photographer can view an image of a scene to be captured by observing the scene on an electronic display. The display electronically shows the user evaluation images that are based upon images that are sensed at the image sensor. When a capture button is triggered, an image of the scene is recorded for future use. A common problem with this system is that the photographer is automatically excluded from such an image as the display and the image capture system are typically disposed on opposite sides of the camera and therefore, the appearance of the photographer at the time of image capture and any and all information that can be determined therefrom is also lost.

What is needed therefore is a camera that is capable of capturing the image of a scene and an image of a photographer, and associating an image of the scene and the image of the photographer therewith for future use.

### SUMMARY OF THE INVENTION

In one aspect of the invention, an image capture device is provided. The image capture device has a scene image capture system adapted to capture an image of a scene and a user image capture system adapted to capture an image of a user of the image capture device. A trigger system is adapted to generate a capture signal and a controller is adapted to receive the capture signal and to cause an image to be captured by the user image capture system and the scene image capture system at substantially the same time. The controller is further adapted to associate the image of the user with the image of the scene.

In another aspect of the invention an image capture device is provided having a scene image capture means for capturing an image of a scene, a user image capture means adapted to capture an image of a user of the image capture means and a trigger system means for generating a capture signal during a time of capture. A control means is provided for receiving the capture signal, for causing at least one of the scene image capture system and the user image capture system to capture video images during the time of capture and to associate the captured scene image and the captured user image to be captured by the user image capture system and the scene image capture system at substantially the same time, and for associating the image of the user with the image of the scene.

An image capture device comprising: a scene image capture means for capturing an image of a scene; a user image capture means adapted to capture an image of a user of the image capture means; a trigger system means for generating a capture signal; and a control means for receiving the capture signal, for causing images to be captured by the user image capture system and the scene image capture system at substantially the same time, and for associating the captured image of the user with the captured image of the scene.

In still another aspect of the invention, an imaging method is provided. In accordance with the method, a capture signal is generated at a time for image capture, an image of a scene is captured and a user image is captured in response to the capture signal. An image of the user is captured synchronized with the captured scene image on the basis of the capture signal and the scene image and the user image are associated.

### BRIEF DESCRIPTION OF THE DRAWINGS

FIG. 1 shows a block diagram of a first embodiment of an image capture device of the invention;

FIG. 2 shows a back view of the embodiment of FIG. 1 in a digital camera form;

FIG. 3 shows a first embodiment of the method of the invention;

FIG. 4 shows an image of an embodiment of the invention presenting a user image, a scene image, a remotely captured user image and a remotely captured scene image; and

FIG. 5 shows a block diagram of another embodiment of the invention wherein a user image capture system is separate from the image capture device.

### DETAILED DESCRIPTION OF THE INVENTION

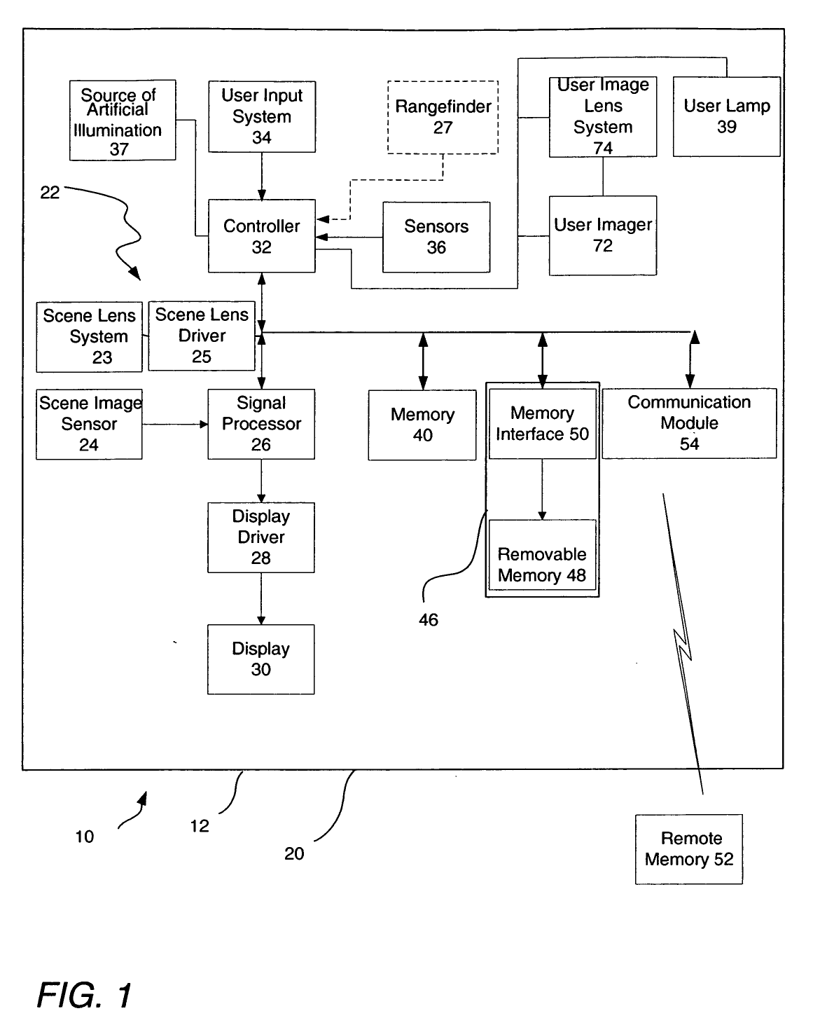

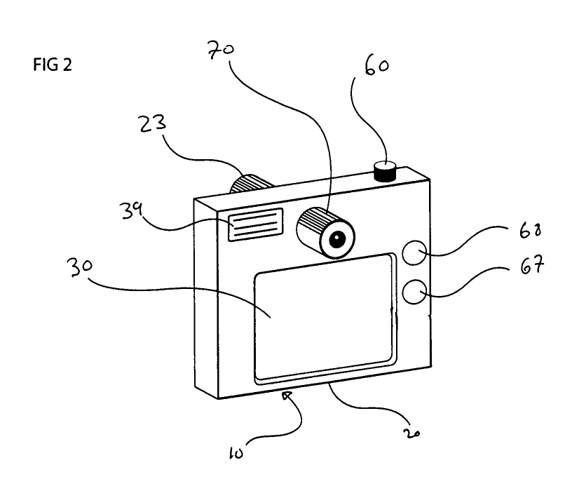

FIG. 1 shows a block diagram of an embodiment of an image capture device 10. FIG. 2 shows a back, elevation view of the image capture device 10 of FIG. 1. As is shown in FIGS. 1 and 2, image capture device 10 takes the form of a digital camera 12 comprising a body 20 containing a scene image capture device 22 having a scene lens system 23, a scene image sensor 24, a signal processor 26, an optional display driver 28 and a display 30. In operation, light from a scene is focused by scene lens system 23 to form an image on scene image sensor 24. Scene lens system 23 can have one or more elements.

Scene lens system 23 can be of a fixed focus type or can be manually or automatically adjustable. In the embodiment shown in FIG. 1, scene lens system 23 is automatically adjusted. In the example embodiment shown in FIG. 1, scene lens system 23 is a 6× zoom lens unit in which a mobile element or elements (not shown) are driven, relative to a stationary element or elements (not shown) by lens driver 25 that is motorized for automatic movement. Lens driver 25 controls both the lens focal length and the lens focus position of scene lens system 23 and sets a lens focal length and/or position based upon signals from signal processor 26, an optional automatic range finder system 27, and/or controller 32.

The focus position of scene lens system 23 can be automatically selected using a variety of known strategies. For example, in one embodiment, scene image sensor 24 is used to provide multi-spot autofocus using what is called the “through focus” or “whole way scanning” approach. As described in commonly assigned U.S. Pat. No. 5,877,809 entitled “Method Of Automatic Object Detection In An Image”, filed by Omata et al. on Oct. 15, 1996, the disclosure of which is herein incorporated by reference. If the target object is moving, object tracking may be performed, as described in commonly assigned U.S. Pat. No. 6,067,114 entitled “Detecting Compositional Change in Image” filed by Omata et al. on Oct. 26, 1996, the disclosure of which is herein incorporated by reference. In an alternative embodiment, the focus values determined by “whole way scanning” are used to set a rough focus position, which is refined using a fine focus mode, as described in commonly assigned U.S. Pat. No. 5,715,483, entitled “Automatic Focusing Apparatus and Method”, filed by Omata et al. on Oct. 11, 1998, the disclosure of which is herein incorporated by reference.

In an alternative embodiment, digital camera 12 uses a separate optical or other type (e.g. ultrasonic) of rangefinder 27 to identify the subject of the image and to select a focus position for scene lens system 23 that is appropriate for the distance to the subject. Rangefinder 27 can operate lens driver 25, directly or as shown in FIG. 1, can provide signals to signal processor 26 or controller 32 from which signal processor 26 or controller 32 can generate signals that are to be used for image capture. A wide variety of suitable multiple sensor rangefinders 27 known to those of skill in the art are suitable for use. For example, U.S. Pat. No. 5,440,369 entitled “Compact Camera With Automatic Focal Length Dependent Exposure Adjustments” filed by Tabata et al. on Nov. 30, 1993, the disclosure of which is herein incorporated by reference, discloses one such rangefinder 27. The focus determination provided by rangefinder 27 can be of the single-spot or multi-spot type. Preferably, the focus determination uses multiple spots. In multi-spot focus determination, the scene is divided into a grid of areas or spots, and the optimum focus distance is determined for each spot. One of the spots is identified as the subject of the image and the focus distance for that spot is used to set the focus of scene lens system 23.

A feedback loop is established between lens driver 25 and camera controller 32 and/or rangefinder 27 so that the focus position of scene lens system 23 can be rapidly set.

Scene lens system 23 is also optionally adjustable to provide a variable zoom. In the embodiment shown lens driver 25 automatically adjusts the position of one or more mobile elements (not shown) relative to one or more stationary elements (not shown) of scene lens system 23 based upon signals from signal processor 26, an automatic rangefinder system 27, and/or controller 32 to provide a zoom magnification. Lens system 23 can be of a fixed zoom setting, manually adjustable and/or can employ other known arrangements for providing an adjustable zoom.

Light from the scene that is focused by scene lens system 23 onto scene image sensor 24 is converted into image signals representing an image of the scene. Scene image sensor 24 can comprise a charge couple device (CCD), a complimentary metal oxide sensor (CMOS), or any other electronic image sensor known to those of ordinary skill in the art. The image signals can be in digital or analog form.

Signal processor 26 receives image signals from scene image sensor 24 and transforms the image signals into an image in the form of digital data. The digital image can comprise one or more still images, multiple still images and/or a stream of apparently moving images such as a video segment. Where the digital image data comprises a stream of apparently moving images, the digital image data can comprise image data stored in an interleaved or interlaced image form, a sequence of still images, and/or other forms known to those of skill in the art of digital video.

Signal processor 26 can apply various image processing algorithms to the image signals when forming a digital image. These can include but are not limited to color and exposure balancing, interpolation and compression. Where the image signals are in the form of analog signals, signal processor 26 also converts these analog signals into a digital form. In certain embodiments of the invention, signal processor 26 can be adapted to process image signal so that the digital image formed thereby appears to have been captured at a different zoom setting than that actually provided by the optical lens system. This can be done by using a subset of the image signals from scene image sensor 24 and interpolating the subset of the image signals to form the digital image. This is known generally in the art as “digital zoom”. Such digital zoom can be used to provide electronically controllable zoom adjusted in fixed focus, manual focus, and even automatically adjustable focus systems.

Controller 32 controls the operation of the image capture device 10 during imaging operations, including but not limited to scene image capture system 22, display 30 and memory such as memory 40. Controller 32 causes scene image sensor 24, signal processor 26, display 30 and memory 40 to capture, present and store scene images in response to signals received from a user input system 34, data from signal processor 26 and data received from optional sensors 36. Controller 32 can comprise a microprocessor such as a programmable general purpose microprocessor, a dedicated micro-processor or micro-controller, a combination of discrete components or any other system that can be used to control operation of image capture device 10.

Controller 32 cooperates with a user input system 34 to allow image capture device 10 to interact with a user. User input system 34 can comprise any form of transducer or other device capable of receiving an input from a user and converting this input into a form that can be used by controller 32 in operating image capture device 10. For example, user input system 34 can comprise a touch screen input, a touch pad input, a 4-way switch, a 6-way switch, an 8-way switch, a stylus system, a trackball system, a joystick system, a voice recognition system, a gesture recognition system or other such systems. In the digital camera 12 embodiment of image capture device 10 shown in FIGS. 1 and 2 user input system 34 includes a capture button 60 that sends a trigger signal to controller 32 indicating a desire to capture an image. User input system 34 can also include other buttons including the mode select button 67, and the edit button 68 shown in FIG. 2.

Sensors 36 are optional and can include light sensors and other sensors known in the art that can be used to detect conditions in the environment surrounding image capture device 10 and to convert this information into a form that can be used by controller 32 in governing operation of image capture device 10. Sensors 36 can include audio sensors adapted to capture sounds. Such audio sensors can be of conventional design or can be capable of providing controllably focused audio capture such as the audio zoom system described in U.S. Pat. No. 4,862,278, entitled “Video Camera Microphone with Zoom Variable Acoustic Focus”, filed by Dann et al. on Oct. 14, 1986. Sensors 36 can also include biometric sensors adapted to detect characteristics of a user for security and affective imaging purposes. Where a need for illumination is determined, controller 32 can cause a source of artificial illumination 37 such as a light, strobe, or flash system to emit light.

Controller 32 causes an image signal and corresponding digital image to be formed when a trigger condition is detected. Typically, the trigger condition occurs when a user depresses capture button 60, however, controller 32 can determine that a trigger condition exists at a particular time, or at a particular time after capture button 60 is depressed. Alternatively, controller 32 can determine that a trigger condition exists when optional sensors 36 detect certain environmental conditions, such as optical or radio frequency signals. Further controller 32 can determine that a trigger condition exists based upon affective signals obtained from the physiology of a user.

Controller 32 can also be used to generate metadata in association with each image. Metadata is data that is related to a digital image or a portion of a digital image but that is not necessarily observable in the image itself. In this regard, controller 32 can receive signals from signal processor 26, camera user input system 34 and other sensors 36 and, optionally, generate metadata based upon such signals. The metadata can include but is not limited to information such as the time, date and location that the scene image was captured, the type of scene image sensor 24, mode setting information, integration time information, scene lens system 23 setting information that characterizes the process used to capture the scene image and processes, methods and algorithms used by image capture device 10 to form the scene image. The metadata can also include but is not limited to any other information determined by controller 32 or stored in any memory in image capture device 10 such as information that identifies image capture device 10, and/or instructions for rendering or otherwise processing the digital image with which the metadata is associated. The metadata can also comprise an instruction to incorporate a particular message into digital image when presented. Such a message can be a text message to be rendered when the digital image is presented or rendered. The metadata can also include audio signals. The metadata can further include digital image data. In one embodiment of the invention, where digital zoom is used to form the image from a subset of the captured image, the metadata can include image data from portions of an image that are not incorporated into the subset of the digital image that is used to form the digital image. The metadata can also include any other information entered into image capture device 10.

The digital images and optional metadata, can be stored in a compressed form. For example where the digital image comprises a sequence of still images, the still images can be stored in a compressed form such as by using the JPEG (Joint Photographic Experts Group) ISO 10918-1 (ITU-T.81) standard. This JPEG compressed image data is stored using the so-called “Exif” image format defined in the Exchangeable Image File Format version 2.2 published by the Japan Electronics and Information Technology Industries Association JEITA CP-3451. Similarly, other compression systems such as the MPEG-4 (Motion Pictures Export Group) or Apple QuickTime™ standard can be used to store digital image data in a video form. Other image compression and storage forms can be used.

The digital images and metadata can be stored in a memory such as memory 40. Memory 40 can include conventional memory devices including solid state, magnetic, optical or other data storage devices. Memory 40 can be fixed within image capture device 10 or it can be removable. In the embodiment of FIG. 1, image capture device 10 is shown having a memory card slot 46 that holds a removable memory 48 such as a removable memory card and has a removable memory interface 50 for communicating with removable memory 48. The digital images and metadata can also be stored in a remote memory system 52 that is external to image capture device 10 such as a personal computer, computer network or other imaging system.

In the embodiment shown in FIGS. 1 and 2, image capture device 10 has a communication module 54 for communicating with external devices such as, for example, remote memory system 52. The communication module 54 can be for example, an optical, radio frequency or other wireless circuit or transducer that converts image and other data into a form, such as an optical signal, radio frequency signal or other form of signal, that can be conveyed to an external device. Communication module 54 can also be used to receive a digital image and other information from a host computer, network (not shown), or other digital image capture or image storage device. Controller 32 can also receive information and instructions from signals received by communication module 54 including but not limited to, signals from a remote control device (not shown) such as a remote trigger button (not shown) and can operate image capture device 10 in accordance with such signals.

Signal processor 26 and/or controller 32 also use image signals or the digital images to form evaluation images which have an appearance that corresponds to scene images stored in image capture device 10 and are adapted for presentation on display 30. This allows users of image capture device 10 to use a display such as display 30 to view images that correspond to scene images that are available in image capture device 10. Such images can include, for example images that have been captured by user image capture system 70, and/or that were otherwise obtained such as by way of communication module 54 and stored in a memory such as memory 40 or removable memory 48.

Display 30 can comprise, for example, a color liquid crystal display (LCD), organic light emitting display (OLED) also known as an organic electro-luminescent display (OELD) or other type of video display. Display 30 can be external as is shown in FIG. 2, or it can be internal for example used in a viewfinder system 38. Alternatively, image capture device 10 can have more than one display 30 with, for example, one being external and one internal.

Signal processor 26 and/or controller 32 can also cooperate to generate other images such as text, graphics, icons and other information for presentation on display 30 that can allow interactive communication between controller 32 and a user of image capture device 10, with display 30 providing information to the user of image capture device 10 and the user of image capture device 10 using user input system 34 to interactively provide information to image capture device 10. Image capture device 10 can also have other displays such as a segmented LCD or LED display (not shown) which can also permit signal processor 26 and/or controller 32 to provide information to user. This capability is used for a variety of purposes such as establishing modes of operation, entering control settings, user preferences, and providing warnings and instructions to a user of image capture device 10.

Other systems such as known circuits, lights and actuators for generating visual signals, audio signals, vibrations, haptic feedback and other forms of signals can also be incorporated into image capture device 10 for use in providing information, feedback and warnings to the user of image capture device 10.

Typically, display 30 has less imaging resolution than scene image sensor 24. Accordingly, signal processor 26 reduces the resolution of image signal or digital image when forming evaluation images adapted for presentation on display 30. Down sampling and other conventional techniques for reducing the overall imaging resolution can be used. For example, resampling techniques such as are described in commonly assigned U.S. Pat. No. 5,164,831 “Electronic Still Camera Providing Multi-Format Storage Of Full And Reduced Resolution Images” filed by Kuchta et al. on Mar. 15, 1990, can be used. The evaluation images can optionally be stored in a memory such as memory 40. The evaluation images can be adapted to be provided to an optional display driver 28 that can be used to drive display 30. Alternatively, the evaluation images can be converted into signals that can be transmitted by signal processor 26 in a form that directly causes display 30 to present the evaluation images. Where this is done, display driver 28 can be omitted.

Scene images can also be obtained by image capture device 10 in ways other than image capture. For example, scene images can by conveyed to image capture device 10 when such images are captured by a separate image capture device and recorded on a removable memory that is operatively associated with memory interface 50. Alternatively, scene images can be received by way of communication module 54. For example, where communication module 54 is adapted to communicate by way of a cellular telephone network, communication module 54 can be associated with a cellular telephone number or other identifying number that for example another user of the cellular telephone network such as the user of a telephone equipped with a digital camera can use to establish a communication link with image capture device 10. In such an embodiment, controller 32 can cause communication module 54 to transmit signals causing an image to be captured by the separate image capture device and can cause the separate image capture device to transmit an scene image that can be received by communication module 54. Accordingly, there are a variety of ways in which image capture device 10 can obtain scene images and therefore, in certain embodiments of the present invention, it is not essential that image capture device 10 use scene image capture system 22 to obtain scene images.

Imaging operations that can be used to obtain a scene image using user image capture system 70 include a capture process and can optionally also include a composition process and a verification process. During the composition process, controller 32 provides an electronic viewfinder effect on display 30. In this regard, controller 32 causes signal processor 26 to cooperate with scene image sensor 24 to capture preview digital images during composition and to present corresponding evaluation images on display 30.

In the embodiment shown in FIGS. 1 and 2, controller 32 enters the image composition process when capture button 60 is moved to a half-depression position. However, other methods for determining when to enter a composition process can be used. For example, one of user input system 34, for example, the edit button 68 shown in FIG. 2 can be depressed by a user of image capture device 10, and can be interpreted by controller 32 as an instruction to enter the composition process. The evaluation images presented during composition can help a user to compose the scene for the capture of a scene image.

The capture process is executed in response to controller 32 determining that a trigger condition exists. In the embodiment of FIGS. 1 and 2, a trigger signal is generated when capture button 60 is moved to a full depression condition and controller 32 determines that a trigger condition exists when controller 32 detects the trigger signal. During the capture process, controller 32 sends a capture signal causing signal processor 26 to obtain image signals from scene image sensor 24 and to process the image signals to form digital image data comprising an scene image.

During the verification process, an evaluation image corresponding to the scene image is optionally formed for presentation on display 30 by signal processor 26 based upon the image signal. In one alternative embodiment, signal processor 26 converts each image signal into a digital image and then derives the corresponding evaluation image from the scene image. The corresponding evaluation image is supplied to display 30 and is presented for a period of time. This permits a user to verify that the digital image has a preferred appearance.

As is also shown in the embodiments of FIGS. 1 and 2, image capture device 10 further comprises a user image capture system 70. User image capture system 70 comprises a user imager 72 and a user image lens system 74. User imager 72 and user image lens system 74 are adapted to capture images of a presentation space in which a user settings can observe evaluation images presented by display 30 during image composition and can provide these images to controller 32 and/or signal processor 26 for processing and storage in the fashion generally described with respect to scene image capture system 22 described above. In this regard, user imager 72 can comprise any the types of imagers described above with respect to scene image sensor 24 and, likewise, user image lens system 74 can comprise any form of lens system described generally above with respect to scene lens system 23. An optional user lens system driver (not shown) can be provided to operate user image lens system 74.

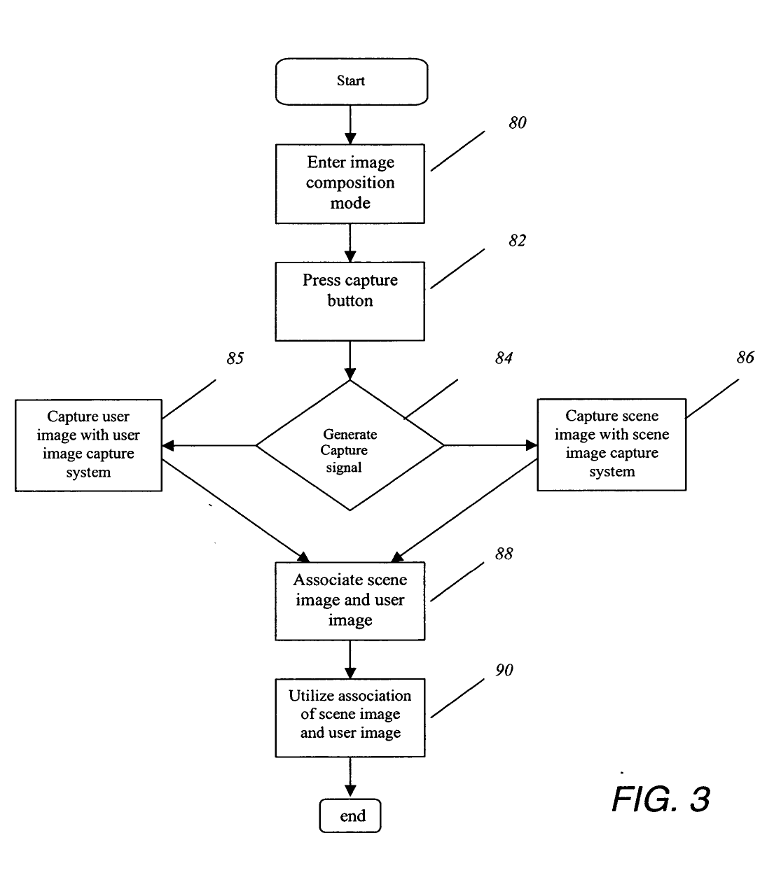

Referring to FIG. 3, what is shown is a first embodiment of a method for operating image capture device 10 in accordance with the present invention. As shown in embodiment of FIG. 3, when a user of an image capture device 10 initiates an image capture operation, as described above, image capture device 10 enters into an image composition mode. (Step 80) During the image capture mode scene image capture system 22 captures images of a scene and presents evaluation images on display 30. User 6 can use these evaluation images to compose a scene for capture.

Conventionally, capture button 60 will be compressible to a half depression position and a full depression position. User 6 depresses capture button 60 to the half depression position, controller 32 enters the image capture composition mode. When capture button 60 is moved to the full depression position, a trigger signal is sent to controller 32 that causes controller 32 to enter into an image capture mode (step 82). When in the image capture mode, controller 32 generates a capture signal (step 84) that causes an image to be captured of the scene (step 86) by scene image capture system 22 and further causes user image capture system 70 to capture an image (step 85) of a user.

As is shown in FIG. 3, the scene image is then associated with the user image (step 88). This can be done by signal processor 26 and/or controller 32 in a variety of fashions. In one embodiment, the captured user image is converted into metadata and stored as metadata in a digital data file containing the scene image. The stored user image can be compressed, down sampled, or otherwise modified to facilitate storage as metadata in a digital data file containing the data representing a captured scene image. For example, the metadata version of the user image can be reduced to reduce the overall memory required to store the user image metadata. Alternatively, signal processor 26 and/or controller 32 can store the captured user image in stegonographic form or as a watermark within the captured scene image so that a rendered image of the captured scene image will contain the user image in a method that allows the user image to be extracted by knowing persons and is not easily separable from the captured scene image.

In still another embodiment, the user image and the scene image can be stored in separate memories with a logical cross-reference stored in association with the captured scene image. For example, the cross-reference can comprise a datalink, web site address, metadata tag or other descriptor that can direct a computer or other image viewing device or image processing device to the location of the captured user image. It will be appreciated that such logical associations can be established in other conventionally known ways, and can also be established to provide a cross reference from the user image to the scene image. Other forms of metadata can be stored in association with either the scene image or user image, such as date, location, time, audio, voice and/or other known forms of metadata. The combination of such metadata and the user image can be used to help discriminate between images.

The scene image and user image can associate so that they can be used in a variety fashions (step 90). In one embodiment of the method, the user image is analyzed to determine an identity for the user. In this embodiment, the user image can be associated with the scene image by storing metadata in the scene image data file such as a name, identity number, biometric data, image data comprising a thumbnail image, or image data comprising some other type of image or other information that can be derived from analysis of the user image and/or analysis of the scene image.

A user identification obtained by analysis of a user image can be used for other purposes. For example, the user identification can be used to obtain user preferences for image processing, image storage, image sharing or other use of the image so that a user image can be automatically associated with the scene image by performing image processing, image storage, image sharing or making other use of the scene image in accordance with such preferences. For example, such user preferences can include predetermined image sharing destinations that allow an image processor to cause the scene image to be directed to a destination that is preferred by the identified user such as an online library of images or a particular destination for a person with whom user 6 frequently shares images. Such use of the user identification can be made by image capture device 10 or some other image using device that receives the scene image, and, optionally the user image.

In another embodiment of the invention, the user image can be associated with the scene image by forming a combination of the scene image and the user image. For example the user image can be composited with the scene image in the form of an overlay, a transparency image, a combination image showing one of the scene image and the user image overlaid upon the other. Alternatively, the scene image and user image can be associated in a temporal sequence such as in any known video data file format. Any known way of combining images can be used. Further, the user image can be combined with the scene image in a combination that allows a print to be rendered with the user image visible on one side and the scene image visible on the other side.

It will be appreciated that scene image capture system 22 and user image capture system 70 can be adapted to capture a scene image that incorporates a sequence of images, streams of image information and/or other form of video signal. In such embodiments, user image capture system 70 can be adapted to capture a user image in the form of a sequence of images, stream of image information, or other form of video signal can be analyzed to select one or more still images from the video signal captured by user image capture system 70 that show the user in a manner that is useful, for example, in determining an identity of the user, preferences of the user, or for combination in still form or in video clip form with an associated video signal from the scene image capture system 22. If desired, still images or video clips can be extracted from a scene or user image captured in video form. These clips can be associated with, respectively, a user image or scene image that corresponds in time to the time of capture of extracted scene or user images. In other embodiments, the video signal from user image capture system 70 can be analyzed so that changes in the appearance of the face of user that occur during a time of capture can be tracked.

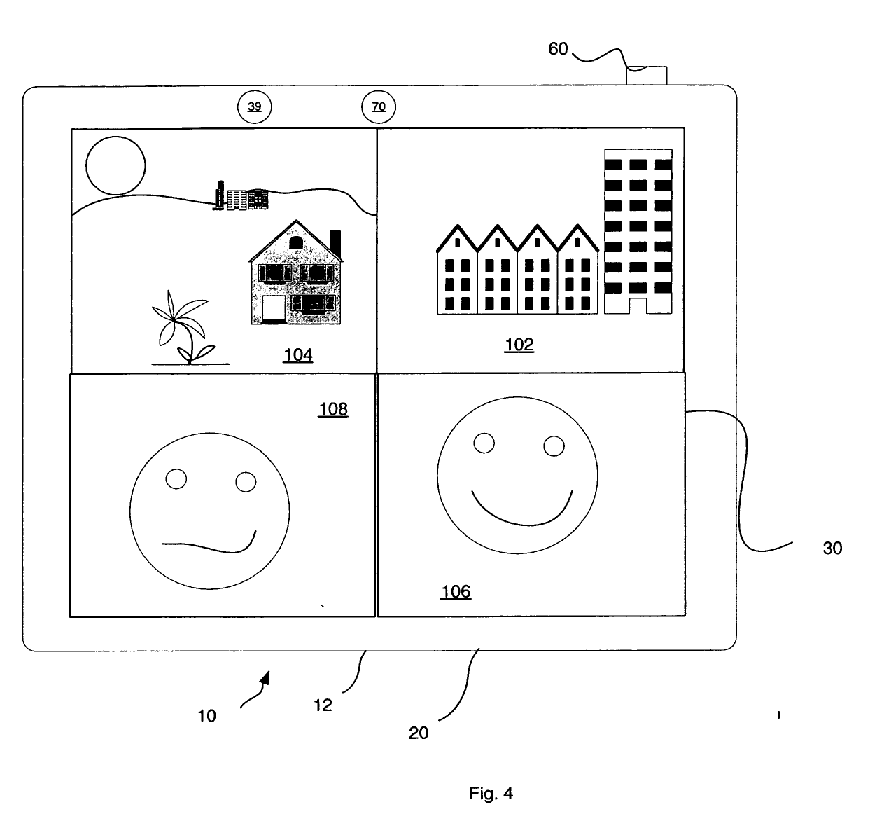

In another embodiment, a video type signal from the user image capture system 70 can be shared with a video type signal from the scene image capture system 22 using communication circuit 54 to communicate with a remote receiver so that a remote observer can observe the scene image video signal and user image video concurrently. In like fashion, communication circuit 54 can be adapted to receive similar signals from the remote receiver and can cause the remotely received signals to be presented on display 30 so that, as illustrated in FIG. 4, display 30 can present a scene image 106, a remotely received scene image 108, a user image 102 and a remotely received user image 104. This enables 2-way video conferencing. The received signals can be stored in a memory such as memory 40.

It will be appreciated that in imaging circumstances where controller 32 determines that a scene image requires artificial illumination to provide an appropriate image of the photographic subject, there will typically also be a need to provide supplemental illumination for the user image. In one aspect of the invention, this need can be met by providing an image capture device that has an artificial illumination system 37 that is adapted to provide artificial illumination to both the scene and the photographer. For example, in the embodiment of FIGS. 1 and 2, a user lamp 39 provides artificial illumination to illuminate the photographer. The illumination provided by user lamp 39 can be in the form of a constant illumination or a strobe as is known in the art. User lamp 39 can be controlled as a part of the source of artificial illumination 37 or can alternatively be directly operated by controller 32.

Alternatively, display 30 can be adapted to modulate the amount of and color of light emitted thereby to provide sufficient illumination at a moment of image capture to allow a user image to be captured. For example, in one embodiment of the invention, the brightness of evaluation images being presented on display 30 can be increased at a moment of capture. Alternatively, at a moment of user image capture, display 30 can suspend presenting evaluation images of the scene and can present, instead, a white or other preferred color of image necessary to support the capture of the user image.

In another embodiment, the need for such artificial illumination upon the user the can be assumed to exist whenever is there is a need determined for artificial illumination in the scene. Alternatively, in other embodiments, the illumination conditions for use capturing a user image can be monitored. In one example of this type, user image capture system 70, signal processor 26 and or controller 32 can be adapted to operate to sense the need for such illumination. Alternatively, sensors 36 can incorporate a rear facing light sensor that is adapted to sense light conditions for the user image and to provide signals to signal processor 26 or controller 32 that enable a determination to be made as to whether artificial illumination is to be supplied for user image capture.

In still another alternative, user image capture system 70 can be adapted to capture the user image, at least in part in a non-visible wavelength such as the infrared wavelength. It will be appreciated that in many cases a user image can be obtained in such wavelengths even when a visible light user image cannot be obtained. In one embodiment, the need to capture an image using such non-visible wavelengths can be assumed to exist whenever a need is determined for artificial illumination in the scene. Alternatively, in other embodiments, the illumination conditions for use capturing a user image can be monitored actively to determine when a user image is to be captured in a non-visible wavelength. In one example of this type, user image capture system 70, signal processor 26 and or controller 32 can be adapted to operate to sense the need for image capture in such a mode. Alternatively, sensors 36 can incorporate a rear facing light sensor that is adapted to sense light conditions for the user image and to provide signals to confer signal processor 26 and/or controller 32 to enable a determination or whether image capture in such a mode is to be allowed.

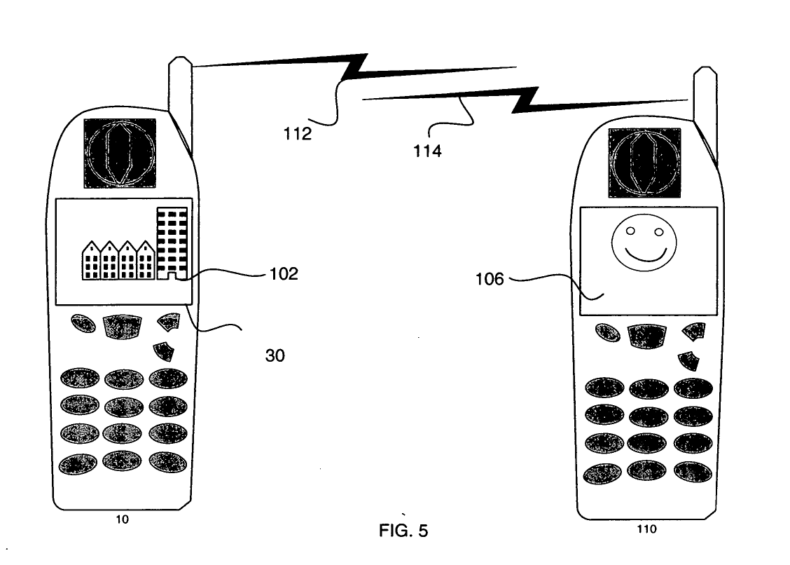

FIG. 5 shows another embodiment of the invention wherein user images can be obtained from devices that are separated from image capture device 10. In FIG. 5, an image capture device 10 is provided that is adapted to communicate using for example, communication module 54, with a separate image capture device 110. In this embodiment, when controller 32 determines that a trigger signal exists, controller 32 causes a capture signal to be sent to signal processor 26 so that a scene image 106 is captured, as described above, and to communication module 54. Communication module 54, in turn, transmits a trigger signal 112 that is detected by separate image capture device 110 and which causes separate image capture device 110 to capture an user image 102 and to transmit a user image signal 114 to communication module 54, which decodes the user image signal 114 and provides it to controller 32 for association with scene image 106.

### Parts List

10 Image capture device
12 digital camera
20 body
22 scene image capture system
23 scene lens system
24 scene image sensor
25 lens driver
26 signal processor
27 rangefinder
28 display driver
30 display
32 controller
34 user input system
36 sensors
37 source of artificial illumination
38 viewfinder system
39 user lamp
40 memory
46 memory card slot
48 removable memory
50 memory interface
52 remote memory system
54 communication module
60 capture button
68 edit button
70 user image capture system
72 user imager
74 user image lens system
80 enter image composition mode step
82 enter image capture mode step
84 generate capture signal step
85 user image capture step
86 scene image capture step
88 associate scene image with user image step
90 associate for use step
102 user image
104 remote user image
106 scene image
108 remote scene image
110 separate image capture device
112 trigger signal
114 user image signal

1. An image capture device comprising:
a scene image capture system adapted to capture an image of a scene,
a user image capture system adapted to capture an image of a user of the image capture device;
a trigger system adapted to generate a capture signal; and
a controller adapted to receive the capture signal and to cause an image to be captured by the user image capture system and the scene image capture system at substantially the same time, said controller further being adapted to associate the image of the user with the image of the scene.

2. The image capture device of claim 1, wherein the controller stores the image of the user in a data file in association with the captured image of the scene.

3. The image capture device of claim 1, wherein the controller comprises an image processing system to process the image of the user.

4. The image capture device of claim 3, wherein the controller processes the image of the user by a means of modifying the image.

5. The image capture device of claim 1, further comprising a display and wherein the controller presents an evaluation image comprising the user image and the scene image on the display.

6. The image capture device of claim 5, further comprising a communication circuit for receiving at least one of a remote user image and a remote scene image from one or more different image capture devices of claim 1.

7. The image capture device of claim 1, further comprising a communication system for transmitting the user image and scene image to a remote device and for receiving a remote scene image and a remote user image from a remote device.

8. The image capture device of claim 7, wherein the controller causes a display to present the user image, scene image, remote user image, and remote scene image on the display at substantially the same time.

9. The image capture device of claim 8, wherein controller is adapted to present at least one of the images in a form that is modified, wherein the image that is modified is selected based on the image analysis of the user image.

10. The image capture device of claim 7, wherein the controller causes a display to present one or more of the remote user image or remote scene image.

11. The image capture device of claim 1, wherein the controller processes the image of the user by extracting affective information therefrom and associating data representing the affective information with the scene image.

12. The image capture device of claim 1, wherein the controller organizes scene images for storage in a memory based upon analysis of at least one of the user image, the scene image or metadata associated therewith.

13. The image capture device of claim 1, wherein the controller is adapted to associate the scene image with the user image by forming an image that combines the scene image and the user image.

14. The image capture device of claim 1, wherein the controller is adapted to associate the scene image with the user image by forming an image that combines the scene image and the user image so that the user image is stored in the scene image in a form that is not readily visible in the scene image but can be recovered therefrom using image analysis.

15. The image capture device of claim 1, wherein at least one of the scene image capture system and the user image capture system is positioned relative to the other one of the scene image capture system and the user image capture system.

16. The image capture device of claim 1, further comprising a communication circuit for communicating with a separate image capture device wherein said controller and said communication module are adapted to cause the separate image capture device to capture at least one of the scene image and the user image.

17. An image capture device comprising:
a scene image capture system adapted to capture at least one image of a scene;
a user image capture system adapted to at least one capture image of a user of the image capture device;
a trigger system adapted to generate a capture signal during a time of capture; and
a controller adapted to cause at least one of the scene image capture system and the user image capture system to capture video images during the time of capture and to associate the scene image and the user image.

18. The image capture device of claim 17, wherein the user images are in the form of at least one of a sequence of images or a stream of image information.

19. The image capture device of claim 17, wherein the user image comprises a video image and the controller is adapted to extract at least one still image from the video user image for use in determining an identity of the user.

20. The image capture device of claim 17, wherein the user image comprises a video image and the controller is adapted to extract at least one still image from the video user image for combination with the scene image.

21. The image capture device of claim 17, wherein the user image comprises a video image and the controller is adapted to analyze the video image to determine changes in the appearance of the user during the time of capture.

22. The image capture device of claim 21, wherein user image and the scene image are video images and wherein the controller is adapted to associate portions of the scene video image that correspond in time to portions of the time of capture at which the controller extracts images of the user from the user video image.

23. The image capture device of claim 17, further comprising source of artificial illumination directed at the user said source of artificial illumination controllable by said controller to supply artificial illumination during capture of the user image.

24. The image capture device of claim 19, wherein the user image capture system is adapted to capture the user image at least in part based upon non-visible wavelengths of light.

25. The image capture device of claim 17, wherein said controller is adapted to determine a need for artificial illumination to facilitate capture of the user image and wherein said controller causes a display to radiate light in a manner that provides the artificial illumination.

26. The image capture device of claim 17, wherein the controller is adapted to determine a user identification based upon the user image.

27. An image capture device comprising:
a scene image capture means for capturing an image of a scene;
a user image capture means adapted to capture an image of a user of the image capture means;
a trigger system means for generating a capture signal; and
a control means for receiving the capture signal, for causing images to be captured by the user image capture system and the scene image capture system at substantially the same time, and for associating the captured image of the user with the captured image of the scene.

28. The image capture device of claim 27, further comprising a means for determining when there is inadequate light received to enable an image to be captured of the user having an adequate exposure level and a means for supplying an artificial illumination onto the user.

29. The image capture device of claim 27, further comprising a means for determining when there is inadequate visible light received to enable an image to be captured of the user having an adequate exposure level and wherein said image capture means is operable to capture an image of the user in a non-visible wavelength when there is inadequate visible light.

30. An imaging method comprising the steps of:
generating a capture signal at a time for scene image capture;
capturing an image of a scene in response to the capture signal;
capturing an image of the user synchronized with the scene image on the basis of the capture signal; and
associating the scene image and the user image.

31. The method of claim 30, further comprising the steps of:
collecting user identification data and associating the scene image and the user image with the user identification data.

32. The method of claim 30, further comprising the step of modifying the image of the user

33. The method of claim 30, further comprising the step of modifying the scene image.

34. The method of claim 30, wherein the image the user image and the scene image are presented for viewing at the same time.

35. The method of claim 30, further comprising the steps of receiving at least one of a remote user image and a remote scene image and presenting the remote user image and a remote scene image for simultaneous viewing.

36. The method of claim 30, further comprising the step of transmitting the user image and scene image to a remote user.

37. The method of claim 35, further comprising the step of presenting each of the user image, the scene image, a received remote user image, and a received remote scene image on the display for viewing at substantially the same time.

38. The method of claim 35, wherein the step of capturing an image of the scene comprises the steps of transmitting a request that a separate image capture system capture an image of the scene or the user, and receiving data representing an image of the scene wherein said request is transmitted at a time determined based upon the capture signal.

39. The method of claim 35, wherein the step of capturing a scene image comprises the steps of transmitting a request that a separate image capture system capture a scene image or a user image, and receiving data representing a scene image wherein said request is transmitted at a time determined based upon the capture signal.
